(19) United States
(12) Patent Application Publication
(10) Pub. No.: US 2018/0247283 A1
(43) Pub. Date: Aug. 30, 2018

(54) SYSTEM AND METHOD FOR PROCESSING BEACON-INITIATED MOBILE TRANSACTIONS

(71) Applicant: MPD Spark LLC, Briarcliff Manor, NY (US)

(72) Inventors: Anthony Milici, Briarcliff Manor, NY (US); Kyle Pearson, Garden City, NY (US); Maxwell Dyke, Hastings on Hudson, NY (US); Albert Bueno, Chapin, SC (US)

(73) Assignee: MPD Spark LLC, Briarcliff Manor, NY (US)

(21) Appl. No.: 15/441,627

(22) Filed: Feb. 24, 2017

(51) Int. Cl. G06Q 20/10; G06Q 20/20; G06Q 20/40; G06Q 20/32

(52) U.S. Cl. CPC G06Q 20/102; G06Q 20/202; G06Q 50/12; G06Q 20/327; G06Q 20/4014

(57) ABSTRACT

A system for processing beacon-based mobile transactions in food and beverage establishments. A ticket for a restaurant customer is automatically generated upon the customer's physical entry into a trusted transaction environment in a restaurant point of sale system (POS) via a mobile application executing on a user device in communication with an application server. The trusted transaction environment corresponds to a virtual perimeter defined by one or more beacons. In an embodiment, a user provides a service worker at the merchant establishment with the user's ticket ID to associate the user's ticket in the POS system. When the user is ready to leave the merchant establishment, the ticket may be paid manually by the user via a graphical user interface, or the user may exit the trusted transaction environment and the system will automatically pay and close the ticket at a predefined interval upon existing the trusted transaction environment.

### FIELD

The present disclosure relates to improvements in the technical field of mobile payment transactions; in particular, a system for establishing a trusted relationship between a smart phone, a merchant point of sale system, and a beacon device to transact mobile payments from a smart phone.

### BACKGROUND

Various embodiments of the present disclosure relate to systems for beacon-based mobile transaction at a merchant location without utilizing the common methods of payment such as cash or credit card. Conventional payment systems require the consumer to perform actions to provide the user account identifiers and other data to the merchant system. This can be done in a variety of ways, such as through magnetic strips on cards, near field communication technologies or utilization of a device application where one follows the prompts to access stored user financial information to process the transaction. For example, the user may be required to tap a start button or initiate an application. In another example, the user may be required to swipe a mobile device to initiate a transaction. In addition, when paying at a merchant location utilizing a transaction kiosk, such as with an automatic pay machine or cashier, there is a necessity to wait for the transaction to be confirmed. In some instances, merchants lose sales when patrons forego buying merchandise due to long wait times to complete a transaction.

In an effort to simplify and speed up a customer's purchasing experience, a variety of mobile payment devices and systems have become more common methods of payment. Numerous prior art solutions exist for enabling mobile and beacon-based transactions. For example, U.S. Pat. No. 9,299,071 to Klingen discloses a system and method for processing a beacon based purchase transaction between a merchant and a customer, where a merchant device sends transaction information to a payment gateway and sends a beacon signal containing a transaction identifier to a customer mobile device to transact a purchase.

U.S. patent application Ser. No. 14/540,004 discloses hands-free transactions using beacon identifiers comprising a server at a payment processing system, a user computing device, and a merchant computing device. The payment processing system registers a merchant system as a hands-free payment participant and provides a beacon identifier. The payment processing system receives a communication from a hands-free payment application on a user computing device, the communication comprising a transaction token, an identification of a user account, and the beacon identifier received by the user computing device via a wireless communication from a device associated with the merchant system and transmits the transaction token to the merchant system computing device. The payment processing system receives from the merchant system computing device, a transaction request, the transaction request comprising the token and transaction data associated with the transaction request and conducts the transaction between the user account and the merchant system based on the received token and transaction request.

Prior art solutions are directed to solutions for the purchase of physical products at retail locations by consumers. However, prior art solutions fail to provide a meaningful solution for the purchase of services in food and beverage establishments, such as restaurants and bars. The logistics of purchase transactions in these types of establishments are fundamentally different than that of retail transactions for physical products. In retail transactions, the customer has physical custody of the product prior to purchase, and may either scan a product identifier with an application running on a smart phone or physically bring the product to a point-of-sale terminal for payment. In a restaurant setting, a customer tab is created in a restaurant point of sale system by a server or bartender. The server or bartender must then keep track of the goods and services requested by the customer, and enter such purchases in a point of sale system for payment. The server or bartender must take physical custody of the customer's credit card, or other form of payment, and complete a purchase transaction in the point of sale system to collect payment for the customer's tab.

Given the logistics of transactions in a restaurant setting, the availability of mobile payment systems is more difficult to enable than that of retail transactions. This is due to the constraints on physical proximity of the customer to a point of sale system, and the ongoing nature of customer purchases during the restaurant experience. What is needed, therefore, is a system and method for enabling hands-free, mobile payments in a bar or restaurant transaction. Through applied effort, ingenuity, and innovation, Applicant has identified a number of deficiencies and problems associated with processing beacon-based mobile payment transactions in food and beverage applications. Applicant has developed a solution that is embodied by the present disclosure, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

An object of the present disclosure is a novel system for a hands-free payment transaction at a merchant establishment without the utilization of a payment machine or individual to complete the transaction.

Another object of the present disclosure is a novel system for a hands-free payment transaction at a food and beverage establishment such that a customer can automatically create and close a tab in a restaurant point of sale system.

Another object of the present disclosure is a novel system for a hands-free payment transaction at a merchant establishment in which a patron does not have to wait or actively participate in the payment transaction.

Specific embodiments of the present disclosure include a hands-free payment transaction at a merchant establishment, which utilizes one or more beacons to identify a user as they enter a merchant establishment.

Another specific embodiment of the present disclosure includes a beacon identifies a user as they exit a merchant establishment and initiates a payment transaction upon departure of the premises.

A further specific embodiment of the present disclosure includes a system for hands-free payment processing of a bar or restaurant ticket, the system comprising means for establishing, with one or more low energy beacon devices, a trusted transaction environment with a customer mobile device, the trusted transaction environment being defined by a physical perimeter corresponding to one or more points of entry and exit in a bar or restaurant; means for identifying, with a customer mobile application executing on the customer mobile device, an instance of customer entry into the trusted transaction environment, the customer mobile application being associated with a customer user account; means for creating, with a point of sale server in communication with the customer mobile application, a ticket in a bar or restaurant point of sale system associated with the customer user account; means for identifying, with the customer mobile application executing on the customer mobile device, an instance of customer exit from the trusted transaction environment; means for processing, with a payment processor, a customer payment associated with the ticket; and, means for communicating, with the point of sale server in communication with the payment processor, a transaction confirmation associated with the customer payment to the point of sale system and the customer mobile application.

A further specific embodiment of the present disclosure includes a method of automatically generating and closing a ticket in a restaurant point of sale system, the method comprising: establishing, with one or more low energy beacon devices, a trusted transaction environment with a customer mobile device, the trusted transaction environment being defined by a physical perimeter corresponding to one or more points of entry and exit in a bar or restaurant; identifying, with a customer mobile application executing on the customer mobile device, an instance of customer entry into the trusted transaction environment, the customer mobile application being associated with a customer user account; creating, with a point of sale server in communication with the customer mobile application, a ticket in a bar or restaurant point of sale system associated with the customer user account; identifying, with the customer mobile application executing on the customer mobile device, an instance of customer exit from the trusted transaction environment; processing, with a payment processor, a customer payment associated with the ticket; and, communicating, with the point of sale server in communication with the payment processor, a transaction confirmation associated with the customer payment to the point of sale system and the customer mobile application.

A further specific embodiment of the present disclosure includes a system for facilitating mobile transactions between a merchant and a customer, the system comprising: one or more low energy beacon devices operably engaged with a remote beacon server, the beacon server executing instructions thereon for identification and management of the one or more low energy beacon devices, the one or more low energy beacon devices defining a trusted transaction environment associated with a physical perimeter of a merchant establishment; a customer application executing over a customer mobile device via a remote application server, the customer application being operable to authenticate a user and the trusted transaction environment, and being operable to establish a ticket in a customer account for purchases associated with the merchant establishment in response to authenticating the user and the trusted transaction environment; a merchant point of sale system operably engaged with a point of sale server, the point of sale server being communicably engaged with the remote application server, the remote application server being configured to communicate the ticket to the point of sale server, and the point of sale server being operable to open the ticket to the merchant point of sale system for purchases associated with the customer account; and, a payment processor operably engaged with the customer application and the point of sale server, the payment processor operable to execute a payment transaction in response to a payment confirmation by the customer application, and communicate a transaction confirmation to the point of sale server and the customer mobile device, the customer application being configured to communicate a payment confirmation to the payment processor in response to the customer mobile device exiting the physical perimeter of the merchant establishment.

The foregoing has outlined rather broadly the more pertinent and important features of the present invention so that the detailed description of the invention that follows may be better understood and so that the present contribution to the art can be more fully appreciated. Additional features of the invention will be described hereinafter, which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a system diagram of an embodiment of a system for processing beacon-based mobile transactions;

FIG. 2 is a flow diagram of the process of starting a tab according to an embodiment of the present disclosure;

FIG. 3 is a flow diagram of the process of closing a tab according to an embodiment of the present disclosure;

FIG. 4 is a flow diagram of the process of leaving a review according to an embodiment of the present disclosure;

FIG. 5 is a process flow diagram illustrating a user checking-in to a merchant establishment in an embodiment of the present disclosure;

FIG. 6 is a process flow diagram illustrating a user closing a tab at merchant establishment in an embodiment of the present disclosure;

FIG. 7 is a process flow diagram illustrating an automatic payment transaction at a merchant establishment; and,

FIG. 8 is a process flow diagram illustrating a user review process according to an embodiment of the present disclosure.

### DETAILED DESCRIPTION

Embodiments of the present disclosure relate to a system for processing beacon-based mobile transactions in food and beverage establishments, such as bars and restaurants. According to an exemplary embodiment, a ticket for a restaurant customer is automatically generated in a restaurant point of sale system (POS) upon the customer's physical entry into a trusted transaction environment via a mobile application executing on a user device in communication with an application server via an internet connection. A user device may include a Smartphone, a tablet computer or other mobile computing device capable of being equipped with a beacon transceiver and an application as described herein. The trusted transaction environment corresponds to a virtual perimeter defined by signals from one or more beacons, and should correspond to the physical perimeter of points of entry and exit in the restaurant. The mobile application generates a ticket ID to associate the user of the mobile application with the ticket in the restaurant point of sale system via an application server in communication with a point of sale system server, the point of sale system server providing a programming interface between the application server and the restaurant POS system. In an embodiment, a user provides the service worker (i.e. server or bartender) at the merchant establishment with the user's name, mobile phone number, or ticket ID to associate the user's ticket with the user's order(s) in the POS system. When the user is ready to leave the merchant establishment, the ticket may be paid and closed manually by the user via a graphical user interface (“GUI”) displayed through the App on the mobile device, or the user may exit the trusted transaction environment and the App will automatically pay and close the ticket at a predefined interval upon existing the trusted transaction environment. Embodiments of the present disclosure enable a user to leave a merchant establishment at will and eliminates the need to wait on a service worker to close the user's tab and facilitate a purchase transaction. Embodiments of the present disclosure improve customer experience for restaurant goers, and enable faster opening and closing of tickets for restaurant owners.

A purchase transaction system is described below which facilitates a purchase transaction between a food and beverage establishment and a customer or patron. As used herein and where appropriate in the context of the description, the term “merchant” may refer to a business, a particular store location or mobile unit of such a business, a specific employee or agent of such a business, and so forth. Similarly, as used herein and appropriate to the context of the description, the term “customer” may refer to an individual who possesses, interacts with and/or owns the customer device, an individual who communicates with the merchant and/or orders food or beverages at a merchant establishment, or an individual, group or entity who maintains a payment account from which funds are drawn to pay for the purchase. The terms “merchant” and “customer” may also apply to private parties engaged in private transactions such as a person-to-person transaction in which one individual is a merchant who provides goods or services, such as food and/or drinks, to another individual who is the customer and who might pay, for example, with a virtual currency such as Bitcoin.

Also as used herein, a “purchase”, “purchase transaction” or “transaction” may refer to, as appropriate, any financial transaction in which one party provides payment to another party, including a bar or restaurant ticket, gratuity, sale, lease, charitable contribution, tip, reimbursement, loan, repayment, settlement, judgment and so forth. In similar fashion, an “item” or “items” may refer to anything for which payment is provided, such as one or more products, services, donations, gratuities, rights, interests and so forth. The appropriate interpretation(s) of the terms “purchase”, “purchase transaction”, “merchant”, “customer”, “item”, “items” and other terms used herein will be comprehended by one of ordinary skill in the art in the context of their use in the description herein, and should be understood to potentially include all potential interpretations reasonably within the scope of the invention.

The purchase transaction system described herein employs “beacon” technology to advantageously facilitate a purchase transaction between a merchant and a customer using a mobile device equipped with such technology. As used herein, beacon technology refers to Bluetooth low energy (also known as Bluetooth LE, BLE, or Bluetooth Smart) technology, or technology based thereon. The term “beacon” as used herein may refer generally to beacon technology or may refer specifically to a device which uses beacon technology, such as a beacon transceiver that transmits a beacon signal to, and/or receives a beacon signal from, other devices that use beacon technology. An example of beacon technology is iBeacon™, provided by or associated with Apple, Inc. A beacon that uses iBeacon technology may be provided by Apple or by another company to be generally compatible with iBeacon technology, and may in some instances be referred to as an iBeacon. An example of an iBeacon-compatible beacon is the Estimote Beacon, which is provided by Estimote, Inc. and certified by Apple.

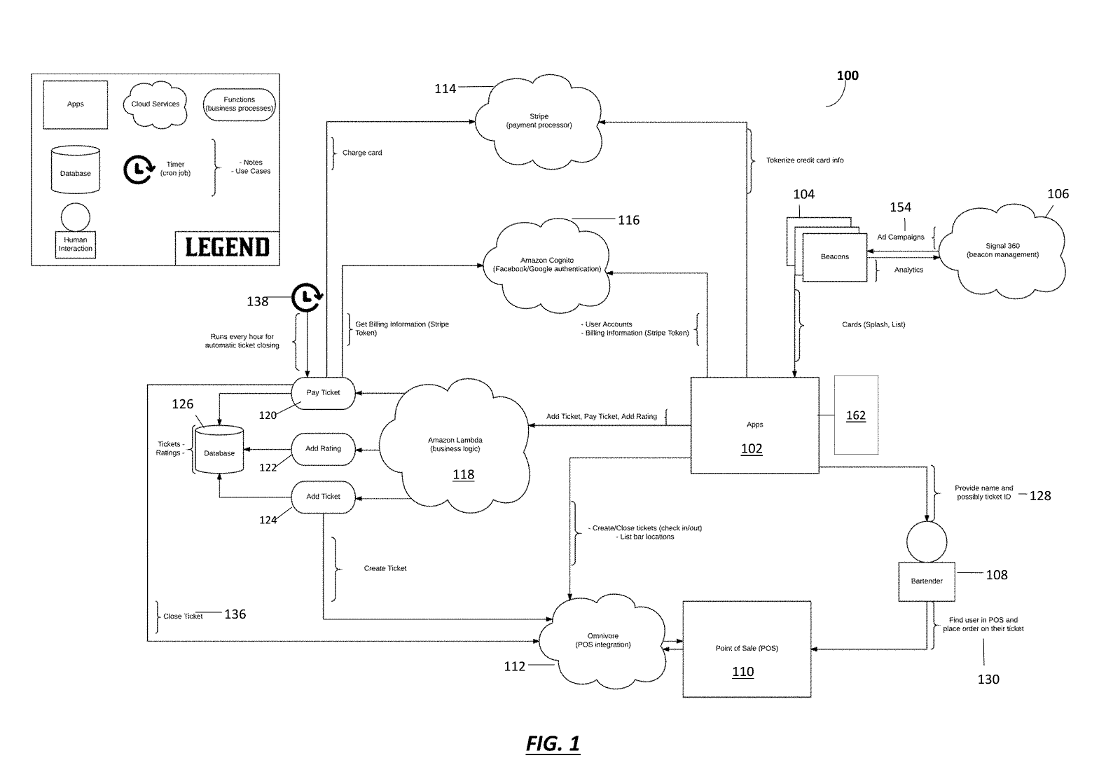

Referring now to FIG. 1, a system diagram of a system 100 for processing beacon-based mobile transactions is shown. According to an embodiment, system 100 is generally comprised of one or more beacons 104 operably engaged with a beacon server 106; a mobile payment software application at least partly resident on and executable by a customer mobile device (“App”) 102; an application server 118 in communication with apps 102; an authentication server 116 in communication with application server 118 and apps 102; a payment processor 114 in communication with with application server 118, a point of sale server 112, and apps 102; and, a point of sale server 112 in communication with apps 102, application server 118, and point of sale system 110.

As shown, App 102 is configured to display a graphical user interface on a user device operable to enable a user to input account and billing information to create a user account. Account and billing information may include information such as name, email, phone number, social account credentials, and credit card information. User account information is stored on authentication server 116, and credit card information is tokenized by authentication server 116 for security purposes. Tokenized credit card information is stored with payment processor 114. App 102 enables communication between user device 162 and payment processor 114, authentication server 116, application server 142 and point of sale server 112 to enable automatic ticket creation in POS system 110 and automatic payment of a ticket in POS system 110 from user device 162. User device 162 may include a Smartphone, a tablet computer or other mobile computing device capable of being equipped with a beacon transceiver and app 102.

According to an exemplary embodiment, beacons 104 transmit beacon signals in a predetermined range to define a trusted transaction environment in a merchant establishment. Beacons 104 may be placed at or near points of entry and exit in a merchant establishment, such that App 102 is able to associate the presence of a beacon signal with user device 162 location inside the trusted environment. Beacons 104 may be operable to encode one or more data packets in the beacon signals. Data may include a beacon identifier for authentication of a merchant establishment by app 102. The trusted transaction environment is defined by the presence of a beacon signal, as well as the authentication of the beacon identifier.

The beacon identifier(s) may be stored in authentication server 116 and associated with a merchant establishment user account. A user may be able to query authentication server 116 via the GUI in app 102 to determine whether a merchant establishment is configured to accept mobile transactions through app 102. Beacons 104 are in communication with beacon server 106 via a communications network (e.g. internet or cellular). Beacon server 106 is operable to communicate advertising campaigns 154 to beacons 104, which in turn may be communicated to app 102. Advertising campaigns 154 may include coupons, discount offers, loyalty credits, and the like. App 102 associates the physical location of user device 162 in the trusted transaction environment upon receiving the beacon signal from beacons 104, and authenticating the beacon identifier in authentication server 116.

System 100 proceeds with executing instructions to establish a ticket in point of sale system 100 in response to app 102 authenticating the trusted transaction environment. App 102 communicates a new ticket request to application server 118. Application server 118 executes instructions to add a ticket 124, including assigning a ticket identifier to the ticket, associating the ticket with the user account and billing information, and storing the ticket information in a database 126. Application server 118 communicates ticket information to POS server 112. POS server 112 creates a ticket in POS system 110 in response to the new ticket information from application server. App 102 may be in communication with POS server 112 such that a user may “check-in” or “check-out” of a merchant establishment.

Upon creating a ticket in POS system 110, a user is able to order food and drinks (or other items) from a merchant establishment employee, such as a bartender 108. The user provides account information, such as name or ticket ID, to bartender 108 to place an order 128. Bartender 108 locates user in POS system 110 and places an order on the user's ticket 130. Additional orders may be added to the user's ticket in the same manner as bartender 108 adds orders to any customer ticket. Purchases made on the user's ticket are communicated from POS system 110 to app 102 via POS server 112. Ticket information from POS system 110 may be displayed on user device 162 via a graphical user interface in app 102, such that a user is able to keep track of his or her purchases at the merchant establishment.

When the user is ready to pay for purchases made on the ticket, the user can either initiate a “pay ticket” workflow via a graphical user interface in app 102, or may simply exit the merchant establishment. If the user chooses to initiate a “pay ticket” workflow via the graphical user interface in app 102, a pay ticket request is communicated from app 102 to application server 118. Application server 118 retrieves the the tokenized billing information associated with the user account, and submits the payment token to payment processor 114 for payment of ticket associated with the merchant establishment. Upon successfully authorizing the transaction, payment processor 114 communicates a transaction confirmation to application server 118 and facilitates the transaction clearing process, including depositing the funds for the ticket in the bank account provided by the merchant establishment in its user account. The transaction confirmation is communicated to POS server 112, which in turn records the ticket as paid in POS system 110. Upon recording the ticket as paid, POS system 110 records the ticket as closed. Application server 118 stores the transaction information 120 in database 126 such that app 102 may query past transactions via the graphical user interface.

Alternatively, a user may close a ticket without taking any action via app 102 by physically leaving the trusted transaction environment. If a user device 162 is removed from the trusted transaction environment, application server 118 executes a timer (e.g. cron job) to facilitate automatic closing of the ticket. The timer should run at predetermined intervals, for example one hour, to determine the physical presence of user device 162 in the trusted transaction environment. If user device 162 is not present in the trusted transaction environment upon expiration of the timer, application server 118 executes instructions to process payment and close the ticket in the same manner as described above. Upon successful payment of the ticket, the user may be prompted to leave a review or rating 122 of the merchant establishment via a graphical user interface in app 102.

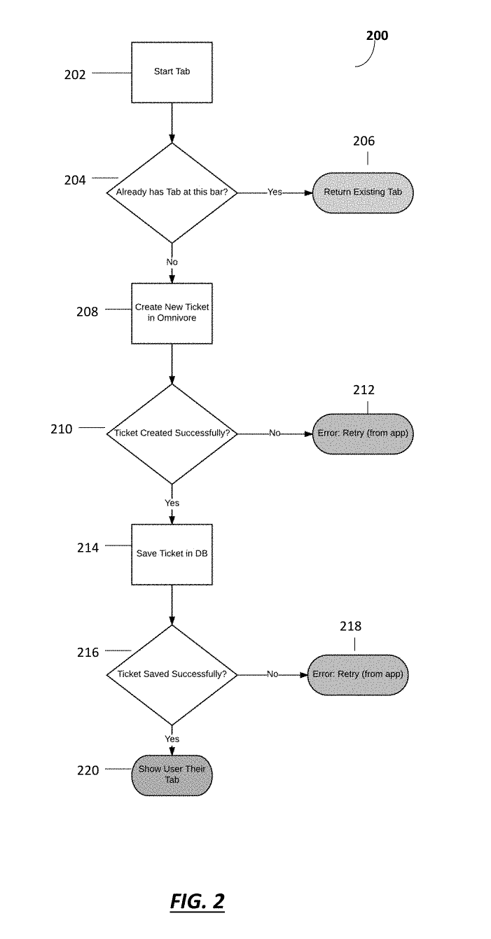

Referring now to FIG. 2, a process flow diagram for starting a tab 200 in a merchant establishment (i.e. bar or restaurant) is shown. According to an embodiment of the present disclosure, a user starts a tab 202 by receiving a beacon signal and authenticating a trusted transaction environment. Upon entering the trusted transaction environment, the system determines whether the user already has a tab at the bar 204. If “YES,” the system will return to the existing tab 206 to the user, and a bartender may associate items ordered with the existing tab. If “NO,” a new ticket is created with a point of sale server 208 and a new tab is entered in the point of sale system located at the merchant establishment. Upon creating a new ticket 208, the application server evaluates whether or not a ticket has been created successfully 210. If the ticket was not successfully created, the application will continue to attempt to create the ticket until the ticket is created or the application has exceeded a predetermined number of authorized attempts. If the ticket is created successfully, the application server saves the ticket in the database 214, and the application server evaluates whether the ticket was saved successfully 216. If “NO,” the application will continue to attempt to save the ticket until the ticket is saved or the application has exceeded a predetermined number of authorized attempts 218. If “YES,” the ticket is saved successfully the application will display the tab to the user via a graphical user interface 220.

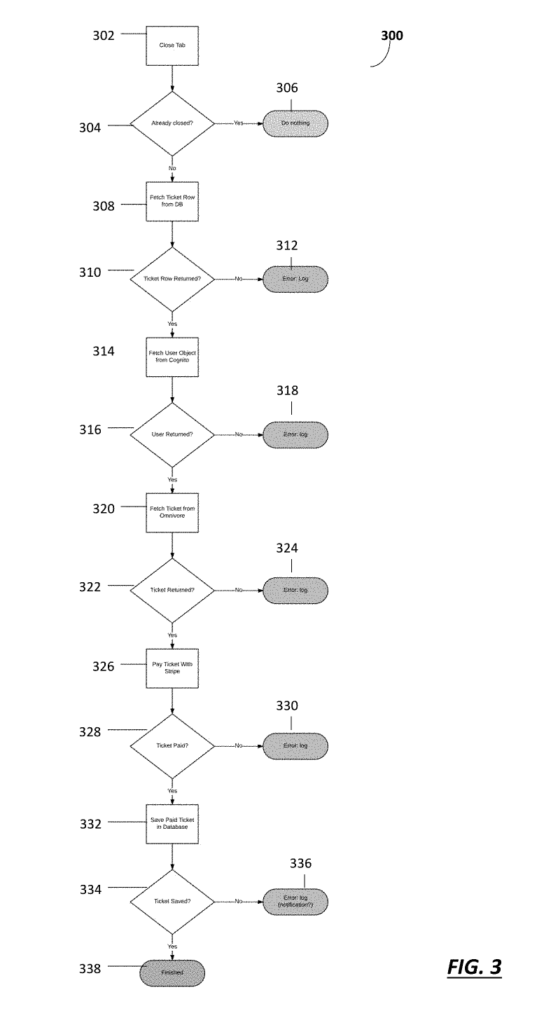

Referring now to FIG. 3, a process flow diagram for closing a tab 300 is shown. According to an embodiment of the present disclosure, the user initiates a request to close tab 302 via a graphical user interface contained in a mobile payment application. Alternatively, the application may initiate the request to close the tab in response to a user exiting the trusted transaction environment for a predetermined period of time. A decision is made by the application server as to whether the tab is already closed 304. If “YES,” then no action is taken and the tab is treated as resolved 306. If “NO,” the ticket row is fetched from the database 308. The application server evaluates whether the ticket row was successfully returned 310. If “NO,” an error is logged 312. If “YES,”, the ticket row is returned and the user token is fetched from the user account information 314.

The application server executes instructions to determine whether the user information is successfully returned 316. If “NO,” the user information is not returned, an error is logged 318. If “YES,” the user information is returned to the application server, and the application server executes addition instructions to fetch the ticket from the point of sale integration server 320. The application server executes further instructions to evaluate whether the ticket from the point of sale integration server has been returned 322. If “NO,” an error is logged 324. If “YES,” the token and user information along with the compared tickets are sent to the payment processing server for payment. The payment processing server processes the payment via the tokenized payment information and associates payment for ticket 326. The application server executes further instructions to evaluate whether the ticket was paid 328. If “NO,” the ticket was not paid, then an error is logged 330. If “YES,” the ticket was paid, the ticket is saved in the application server database 332. The application server executes further instructions to evaluate whether the ticket was saved 334. If “NO,” the ticket was not saved, then an error is logged 336. If “YES,” the ticket was saved in the application server database than closing the tab is finished 338.

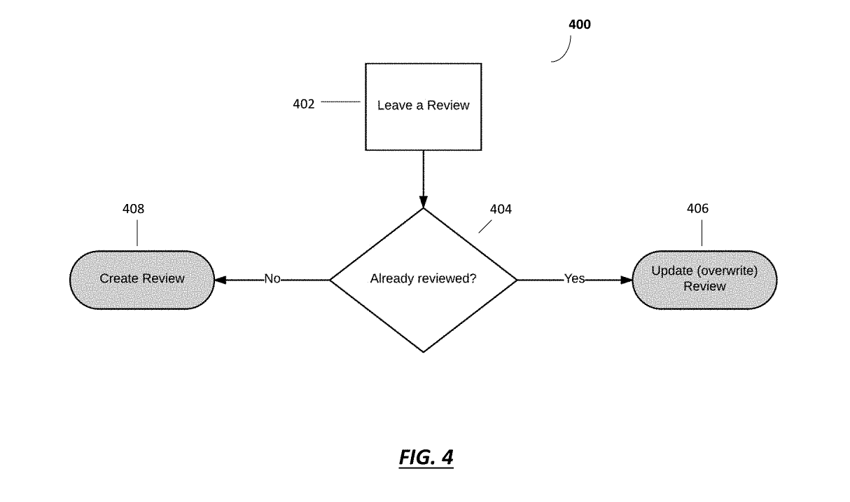

Referring now to FIG. 4, a process flow diagram for leaving a review of the merchant establishment 400 is shown. According to an embodiment of the present disclosure, a user to leave a review 402 via a graphical user interface displayed over a mobile payment application executing over a user device. The application server executes instructions to evaluate whether the merchant establishment has already been reviewed 404 by the user. If “YES,” a previous review is present, the application server updates and overwrites the previous review 406. If “NO,” the merchant establishment has not been reviewed, the application server creates a review 408 in response to user generated content submitted by the user via the graphical user interface.

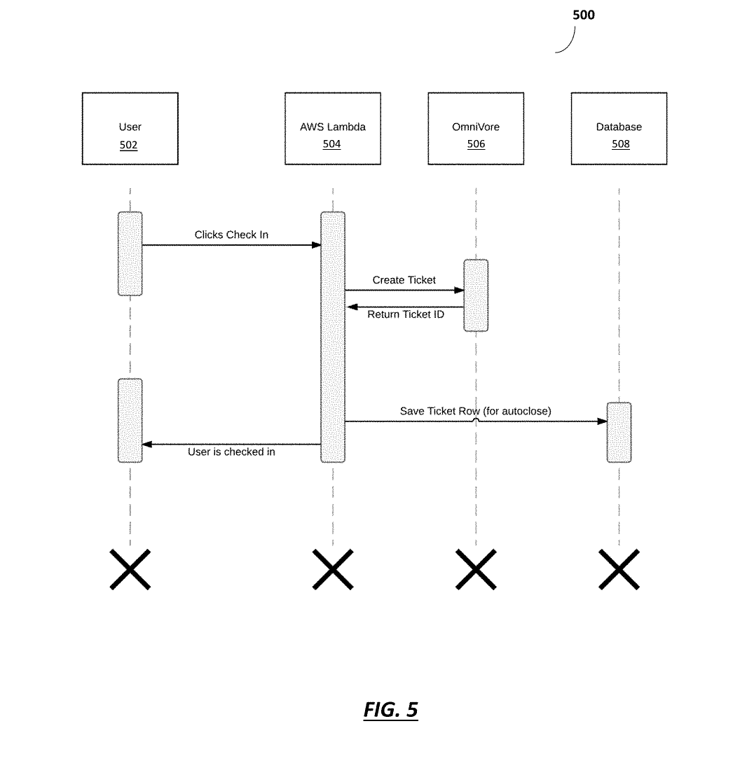

Referring now to FIG. 5, a system diagram showing the data flow between system servers in response to a user checking-in to a merchant establishment 500 is shown. According to an embodiment, the user 502 clicks “check-in” via a graphical user interface displayed over a mobile payment application executing over a user device, and the application server 504 creates a ticket by communicating a ticket request to a point of sale integration server 506. Point of sale integration server 506 returns a ticket ID to the application server 504. The ticket row is saved in the application server database 508 and awaits a request for manual or automatic closing of the ticket via the application. The application server 504 confirms that the user is checked-in in the application, and the merchant establishment is able to allocate purchases made by the user against the ticket in the point of sale system.

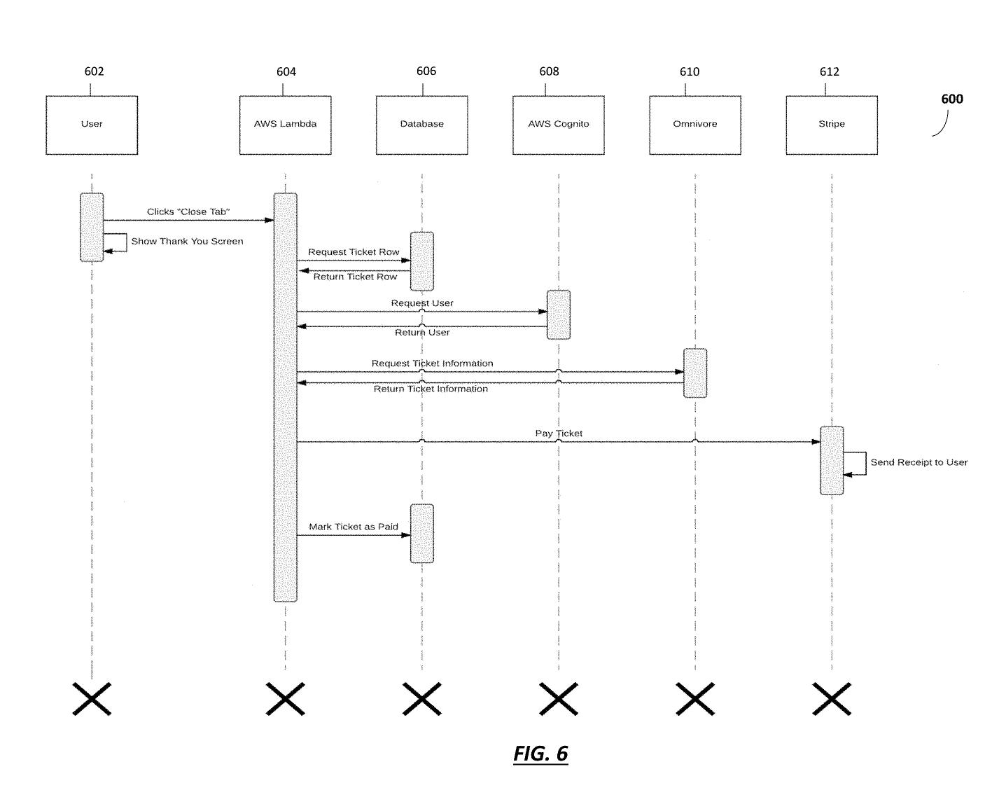

Referring now to FIG. 6, a system diagram showing the data flow between system servers in response to a request to closes a tab 600 is shown. According to an embodiment, a user 602 clicks a “close tab” button via a graphical user interface displayed over a mobile payment application executing over a user device. This action sends a command to the application server 604 to execute instructions to request and retrieve the ticket row from the database 606. Once the ticket row has been retrieved, the application server 604 requests and receives verified user account information and billing information encrypted in a token from the user server 608. The application server requests ticket information from the point of sale integration server 610. The point of sale information verifies the items ordered in the merchant point of sale system with the ticket saved in the application server database 606. Once the compared tickets are verified, the application server sends the amount to be paid along with the user information and token to the payment processing server 612. The payment server 612 uses the user account information and decodes the token billing information and processes payment of the tab. The payment processing server 612 sends a receipt to the user 602 via the mobile payment application executing over the user device. The application server 604 changes the status of the ticket to “paid” and saves the paid ticket in the database 606.

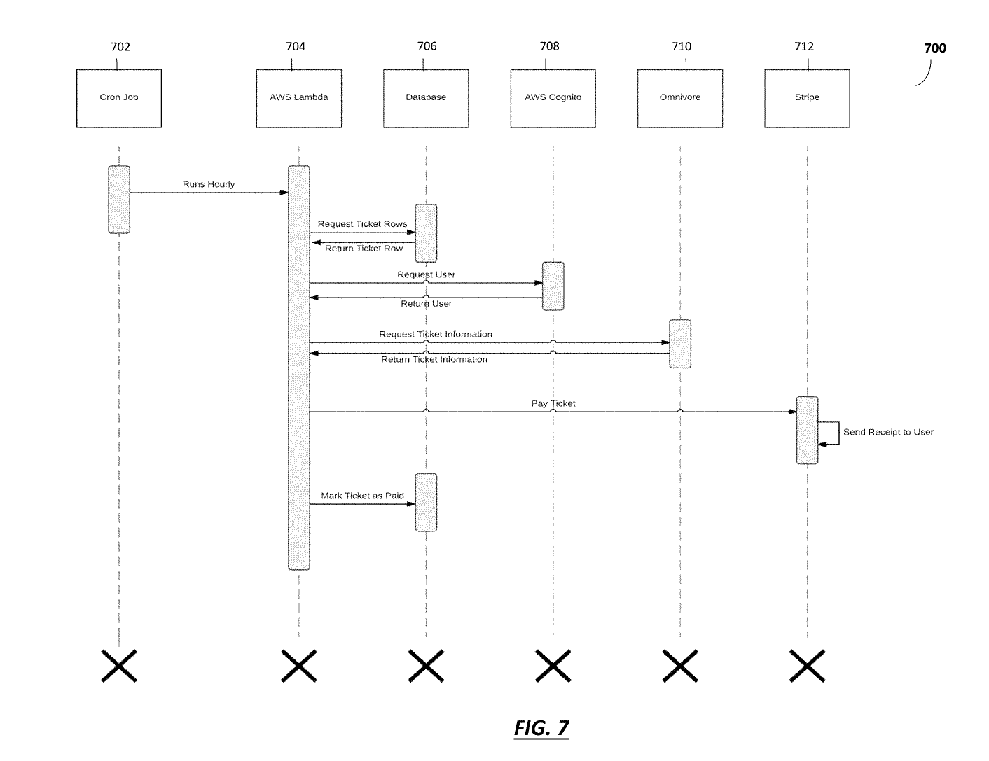

Referring now to FIG. 7, a system diagram showing the data flow between system servers in response to an instruction to automatically close a tab 700 is shown. According to an embodiment, a timer 702 initiates a command at predetermined intervals, e.g. hourly, to an application server 704. Application server 704 requests and retrieves the ticket row from the database 706 in response to expiration of timer 702. Once the ticket row has been retrieved, the application server 704 requests and receives verified user account information and billing token from the user server 708. The application server requests ticket information from the point of sale integration server 710. The point of sale integration server verifies the items ordered in the merchant point of sale system with the ticket saved in the application server database 706. Once the transaction details are verified, the application server sends the amount to be paid along with the user information and token to the payment processing server 712. The payment server 712 uses the user account information and decodes the payment token to process payment of the tab. The payment processing server 712 sends a receipt to the user 702 via the mobile payment application executing over the user device. The application server 704 changes the status of the ticket to “paid” and saves the paid ticket in the database 706.

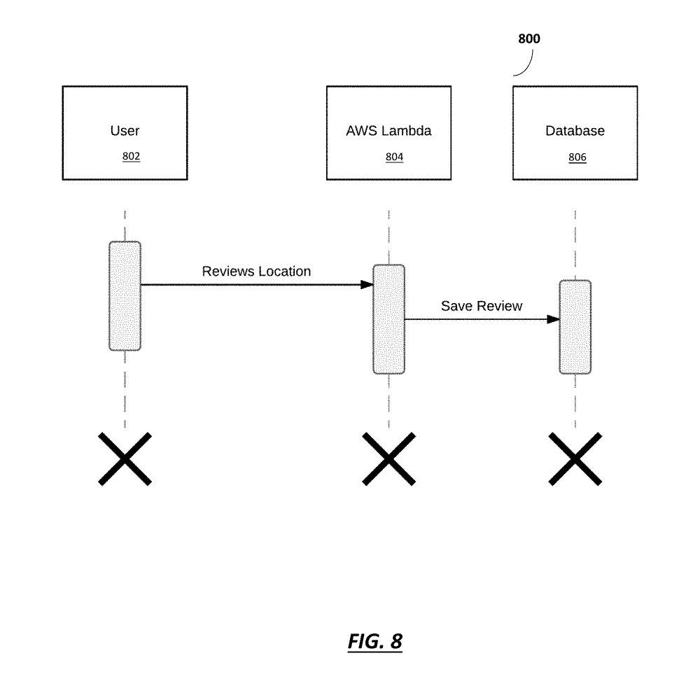

Referring now to FIG. 8, a system diagram showing the data flow between system servers in response to an input of a user-generated review of a merchant establishment 800 is shown. According to an embodiment, a user 802 generates a review of a merchant establishment via a graphical user interface displayed over a mobile payment application executing over a user device. The user generated content is communicated to the application server 804. The application server evaluates whether a review has already been created for the merchant establishment by the user 802. If a review has already been created, the application server 804 overwrites the previous review. If a review has not been created, the application server 804 changes the status of the ticket to “paid” and saves the paid ticket in the database 806.

It should be appreciated that a hands-free transaction system has been described which employs beacon technology and a plurality of function-specific servers operably engaged via a communications network (e.g. internet or cellular) to enable a customer mobile device to automatically open a ticket in a restaurant point of sale system upon entering a restaurant, and automatically close a ticket and facilitate a payment transaction upon exiting a restaurant. In the foregoing specification, it should be appreciated that the particular implementations shown and described herein are illustrative of the invention and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections might be present in a practical system.

The present invention may be described herein in terms of functional block components, optional selections and/or various processing steps. It should be appreciated that, unless otherwise stated or more specifically described herein, such functional blocks may be realized by any number of hardware and/or software components suitably configured to perform the specified functions. Furthermore, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

Any system components discussed herein which involve the storage, access, reference, comparison, match or retrieval of data or similar functions, unless otherwise stated or more specifically defined, may be implemented with any appropriate system, including any type of database, such as relational, hierarchical, graphical, object-oriented, and/or other database configurations. Similarly, processing steps involving the performance of such functions may likewise be performed with any such appropriate system.

Unless otherwise stated or more specifically defined, the present invention may employ any number of conventional techniques for data transmission, messaging, data processing, network control, and/or the like. One skilled in the art will appreciate that, unless otherwise stated or more specifically described herein, a network may include any system for exchanging data or transacting business, such as the Internet, an intranet, an extranet, WAN, LAN, satellite communications, cellular network, and/or the like.

It should also be appreciated that any number of available security measures may be applied as appropriate to protect information at all stages of the purchase transaction including, but not limited to encryption, password or PIN number protection, speaker recognition and any biometric applications appropriate to secure and facilitate the functions described herein such as facial recognition, fingerprint detection, retinal scanning and so on.

The invention has been described with reference to specific embodiments. However, it may be appreciated that various modifications and changes may be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A system for hands-free payment processing of a bar or restaurant ticket, the system comprising:
means for establishing, with one or more low energy beacon devices, a trusted transaction environment with a customer mobile device, the trusted transaction environment being defined by a physical perimeter corresponding to one or more points of entry and exit in a bar or restaurant;
means for identifying, with a customer mobile application executing on the customer mobile device, an instance of customer entry into the trusted transaction environment, the customer mobile application being associated with a customer user account;
means for creating, with a point of sale server in communication with the customer mobile application, a ticket in a bar or restaurant point of sale system associated with the customer user account;
means for identifying, with the customer mobile application executing on the customer mobile device, an instance of customer exit from the trusted transaction environment;
means for processing, with a payment processor, a customer payment associated with the ticket; and,
means for communicating, with the point of sale server in communication with the payment processor, a transaction confirmation associated with the customer payment to the point of sale system and the customer mobile application.

2. The system of claim 1 further comprising means for authenticating, with an authentication server, a customer identity associated with the customer user account.

3. The system of claim 1 further comprising a beacon server communicably engaged with the one or more low energy beacon devices, the beacon server containing one or more unique beacon identifiers associated with the one or more low energy beacon devices.

4. The system of claim 1 further comprising a customer application server operably engaged with the customer mobile application executing on the customer mobile device.

5. The system of claim 1 further comprising means for associating, with a business user application executing over a web browser, the one or more low energy beacon devices with a business user account, the business user account containing information corresponding to the bar or restaurant.

6. The system of claim 3 wherein the means for identifying the customer entry into the trusted transaction environment further comprises identification of the one or more unique beacon identifiers by the customer mobile application.

7. The system of claim 5 further comprising means for communicating, with the customer mobile application, selected business user account information corresponding to the bar or restaurant to the customer mobile device.

8. The system of claim 1 further comprising means for inputting, with the customer mobile application executing on the customer mobile device, user generated content corresponding to customer experience associated with the bar or restaurant.

9. The system of claim 1 further comprising means for initiating, with the customer mobile application, a timing module in response to the instance of customer exit from the trusted transaction environment, and means for initiating payment processing for the ticket in response to an expiration of the timing module.

10. The system of claim 2 wherein the means for authenticating the customer identity associated with the customer user account further comprises communicating with one or more third-party applications.

11. A method of automatically generating and closing a ticket in a restaurant point of sale system, the method comprising:
establishing, with one or more low energy beacon devices, a trusted transaction environment with a customer mobile device, the trusted transaction environment being defined by a physical perimeter corresponding to one or more points of entry and exit in a bar or restaurant;
identifying, with a customer mobile application executing on the customer mobile device, an instance of customer entry into the trusted transaction environment, the customer mobile application being associated with a customer user account;
creating, with a point of sale server in communication with the customer mobile application, a ticket in a bar or restaurant point of sale system associated with the customer user account;
identifying, with the customer mobile application executing on the customer mobile device, an instance of customer exit from the trusted transaction environment;
processing, with a payment processor, a customer payment associated with the ticket; and,
communicating, with the point of sale server in communication with the payment processor, a transaction confirmation associated with the customer payment to the point of sale system and the customer mobile application.

12. The method of claim 11 further comprising authenticating, with an authentication server, a customer identity associated with the customer user account.

13. The method of claim 11 further comprising a beacon server communicably engaged with the one or more low energy beacon devices, the beacon server containing one or more unique beacon identifiers associated with the one or more low energy beacon devices.

14. The method of claim 11 further comprising a customer application server operably engaged with the customer mobile application executing on the customer mobile device.

15. The method of claim 11 further comprising associating, with a business user application executing over a web browser, the one or more low energy beacon devices with a business user account, the business user account containing information corresponding to the bar or restaurant.

16. The method of claim 13 wherein identifying the customer entry into the trusted transaction environment further comprises identifying the one or more unique beacon identifiers by the customer mobile application.

17. The method of claim 15 further comprising communicating, with the customer mobile application, selected business user account information corresponding to the bar or restaurant to the customer mobile device.

18. The method of claim 11 further comprising inputting, with the customer mobile application executing on the customer mobile device, user generated content corresponding to customer experience associated with the bar or restaurant.

19. The method of claim 11 further comprising initiating, with the customer mobile application, a timing module in response to the instance of customer exit from the trusted transaction environment, and initiating payment processing for the ticket in response to an expiration of the timing module.

20. A system for facilitating mobile transactions between a merchant and a customer, the system comprising:
one or more low energy beacon devices operably engaged with a remote beacon server, the beacon server executing instructions thereon for identification and management of the one or more low energy beacon devices, the one or more low energy beacon devices defining a trusted transaction environment associated with a physical perimeter of a merchant establishment;
a customer application executing over a customer mobile device via a remote application server, the customer application being operable to authenticate a user and the trusted transaction environment, and being operable to establish a ticket in a customer account for purchases associated with the merchant establishment in response to authenticating the user and the trusted transaction environment;
a merchant point of sale system operably engaged with a point of sale server, the point of sale server being communicably engaged with the remote application server, the remote application server being configured to communicate the ticket to the point of sale server, and the point of sale server being operable to open the ticket to the merchant point of sale system for purchases associated with the customer account; and,
a payment processor operably engaged with the customer application and the point of sale server, the payment processor operable to execute a payment transaction in response to a payment confirmation by the customer application, and communicate a transaction confirmation to the point of sale server and the customer mobile device, the customer application being configured to communicate a payment confirmation to the payment processor in response to the customer mobile device exiting the physical perimeter of the merchant establishment.
